(19) United States
(12) Patent Application Publication
(10) Pub. No.: US 2006/0160932 A1
(43) Pub. Date: Jul. 20, 2006

(54) Heat activated sealants and foamed materials

(76) Inventors: Donald W. Taylor, Liberty, MO (US); James W. Freitag, Kearney, MO (US)

Correspondence Address: ORSCHELN MANAGEMENT CO, P O BOX 280, 2000 US HIGHWAY 63 SOUTH, MOBERLY, MO, 65270, US

(21) Appl. No.: 11/326,819

(22) Filed: Jan. 6, 2006

Related U.S. Application Data
(60) Provisional application No. 60/642,920, filed on Jan. 7, 2005.
(60) Provisional application No. 60/646,027, filed on Jan. 21, 2005.
(60) Provisional application No. 60/656,580, filed on Feb. 25, 2005.

(51) Int. Cl. C08L 63/00

(52) U.S. Cl. 523/458

(57) ABSTRACT

The disclosure related curing agents used in automotive sealants and foamed materials and comprises at least one epoxy functional compound and an effective amount of at least one metallic acrylate, metallic diacrylate, metallic monomethacrylate, metallic dimethacrylate compounds, among others.

This application claims the benefit of Provisional Application No. 60/642,920, filed Jan. 7, 2005, Application No. 60/646,027, filed Jan. 21, 2005 and Application No. 60/656,580, filed Feb. 25, 2005. The disclosure of the Provisional Applications is hereby incorporated by reference.

### FIELD OF THE INVENTION

The subject matter of the instant invention relates to metal acrylate curing agents that can be used in heat activated sealants and foamed materials (e.g., automotive sealants, sound abatement, structural, and energy absorbing materials).

### BACKGROUND OF THE INVENTION

Epoxy functional compounds and systems are known in this art and employed in a wide range of applications and formulations. By “epoxy functional system” it is meant to refer to a mixture or blend containing at least one epoxy functional compound and at least one curing agent for the compound. Examples of such systems comprise automotive and industrial adhesives/sealants, corrosion resistance coatings, films and paints, pre-preg, tapes, gels, and hand lay-up structural composites, powder coatings/films/paints, adhesives, films, among other applications.

It is known in this art to employ curing agents to affect or control curing of epoxy functional compounds. Conventional epoxy curing agents include amidoamines, amines, amine complexes, anhydrides, aziridines, boron trifluoride and complexes, carboxyl-terminated polyesters, catalytic (e.g., benzyldimethylamine (BDMA), boron trifluoride monoethylamine (BF₃.MEA), 2-methylimidazole (2-MI)), dicyandiamide, imidizoles, imidizole complexes, melamines, melamine/formaldehyde, phenol/formaldehyde, polyamides, polysulfides, substituted ureas, ureas, urea/formaldehyde among other conventional curing agents. Formulations containing such epoxy curing agents can be heat activated. While these curing agents are effective at curing epoxy functional compounds, formulations containing these curing agents can have decreased shelf stability when catalysts are included (e.g., catalysts to decrease activation temperature), are incompatible with many types of fillers, produce either relatively soft or rough surfaces, can cause paint staining, dark or discolored film, shrinkage of the compound, among other undesirable characteristics. Epoxy functional systems such as coatings, films, adhesives, sealers, gels, among others, that employ conventional curing agents also suffer these negative characteristics. Conventional curing agents may also be environmentally undesirable.

There is a need in this art for sealants and foamed materials (e.g., automotive sealant, sound abatement, structural, and energy absorbing materials) that employ a curing agent for an epoxy functional system that results in a cured system having improved shrinkage resistance, reduced off-gassing, reduced odor, clarity, lower curing temperature, shelf stability, less charring, increased hardness, reduced paint staining, controlled expansion, among other properties not achieved by conventional curing agents.

### CROSS REFERENCE TO RELATED PATENTS AND PATENT APPLICATIONS

The subject matter of the instant invention is related to the following U.S. patent application Ser. Nos. 10/729,339, entitled “Metal-Acrylates as Curing Agents for Polybutadiene, Melamine and Epoxy”, 10/978,081 entitled “Metal-Acrylate Curing Agents, and 11/003,758 entitled “Metallic Acrylate Curing Agents And Usage Thereof In Intermediate Compositions”. The disclosure of these patent applications is hereby incorporated by reference.

### DESCRIPTION OF THE INVENTION

The instant invention solves problems associated with conventional curing agents used in sealants and foamed materials by employing at least one epoxy functional compound and an effective amount of at least one metallic acrylate, metallic diacrylate, metallic monomethacrylate, metallic dimethacrylate compounds, among others (collectively and individually reference herein as “metallic acrylate”). By an effective amount it is meant that the amount of metallic diacrylate is sufficient to cure at least a portion of the composition, e.g., about 1 to about 98 wt. % and typically about 5 to about 20 wt. % of metallic diacrylate (e.g., about 6 to about 12 wt %) and typically about 20 to about 80 wt. % of an intermediate product. The specific amount of metallic acrylate will vary depending upon the concentration of resin or polymer to be cured, whether an intermediate product comprising metallic acrylate is employed, processing time/temperatures, among other variables. The metallic diacrylate can provide other benefits while also acting as a curing agent such as reduced shrinkage, improved clarity or transparent coatings, improved heat aging, improved shelf life, among other benefits. While any suitable metallic diacrylate can be employed, examples of suitable diacrylates comprise at least one member selected from the group consisting of zinc diacrylate (ZDA), zinc dimethacrylate (ZDMA), magnesium diacrylate, aluminum diacrylate, aqueous or other solutions or dispersions of metallic acrylate monomers, among others. Zinc diacrylates and zinc dimethacrylates (e.g., ZDA and ZDMA) are especially useful for curing epoxy functional systems.

ZDA and ZDMA containing compounds will interact with or cure at least the epoxy functional component of the epoxy functional system while being substantially free of conventional curing agents. By “substantially free of conventional curing agents”, it is meant that an epoxy functional compound (or other compound curable with metallic diacrylates or dimethacrylates), is cured while in the presence of less than about 0.1 to about 1.0 wt. % (e.g., about 0% of conventional epoxy curing agents) of the following compounds amidoamines, amines, amine complexes, anhydrides, aziridines, boron trifluoride and complexes, catalytic (e.g., benzyldimethylamine (BDMA), boron trifluoride monoethylamine (BF₃.MEA), 2-methylimidazole (2-MI)), dicyandiamide, imidizoles, imidizole complexes, melamines, melamine/formaldehyde, phenol/formaldehyde, polyamides, polysulfides, substituted ureas, ureas, urea/imidizole compounds, melamines, melamine/formaldehyde, phenol/formaldehydes, polyamides, polysulfides, carboxyl-terminated polyesters, substituted ureas, ureas, urea/formaldehyde, among other conventional curing agents. While the instant invention can be practiced in combination with such conventional curing agents, the instant invention eliminates the necessity of such compounds, among other benefits.

The instant invention relates to using metallic diacrylate compounds such as zinc diacrylate (ZDA), zinc dimethacrylate (ZDMA), mixtures thereof, among others for curing epoxy functional and other cross-linking or reactive compounds, and to systems containing such compounds (e.g., automotive sealant, sound abatement, structural, and energy absorbing materials). The metallic diacrylates or metallic acrylates or metallic monomethacrylates or metallic dimethacrylate or mixtures thereof, among others, can be employed to cure a wide range of systems. Examples of such systems comprise at least one curable polymer selected from the group consisting of polybutadiene, melamine, isocyanates, epoxy and epoxy functional compounds such as bis A, bis F, cycloaliphatic epoxy, novolac, epoxy esters, polyesters, acrylates, phenolic modified alkyds, alkyds, acrylic alkyd copolymers, Blox (epoxy resin/alkanolamine polymer), phenoxy modified epoxy, among other systems. The amount of curable polymer will normally range from about 1 to about 99 wt % (e.g., about 75 to about 90 wt. % and in some cases about 10 to about 60 wt. %).

The use of metallic diacrylates such as zinc diacrylate (ZDA), zinc dimethacrylate (ZDMA), magnesium diacrylate, aluminum diacrylate, hydroxy functional metallic monomethacrylates, aqueous dispersions or solutions of metallic acrylate monomers, among others, as a curing agent, for example, epoxy functional systems (e.g., sealants, structurals and sound abatement materials that are activated by the heat employed when curing paint on an automobile or similar industrial process), can be an effective replacement for amidoamines, amines, amine complexes, anhydrides, aziridines, boron trifluoride and complexes, carboxyl-terminated polyesters, catalytic (e.g., benzyldimethylamine (BDMA), boron trifluoride monoethylamine (BF₃.MEA), 2-methylimidazole (2-MI)), dicyandiamide, imidizoles, imidizole complexes, melamines, melamine/formaldehyde, phenol/formaldehyde, polyamides, polysulfides, substituted ureas, ureas, urea/formaldehyde, metallic naphthanates (cobalt, zinc, among other metals), or other conventional heat activated cures. The ability to reduce, if not eliminate, the usage of conventional curing agents can reduce environmental hazards that have been associated with many conventional curing agents.

The metallic acrylate (e.g., metal acrylate, metallic diacrylate, metallic dimethacrylate, or metallic monomethacrylate) curing agents of the invention can be easily blended with solid or liquid epoxy resins, or mixtures of liquid and solid resins in order to produce epoxy functional systems such as relatively clear coatings, coatings with reduced shrinkage, different cure responses, reduced staining of an overlying paint, structural materials, among other properties. The replacement of dicyandiamide or other conventional curing compounds with metallic diacrylate or dimethacrylate can usually be accomplished without significant changes in the manner in which the epoxy functional systems are prepared. The inventive epoxy functional systems are normally heat activated (e.g., at a temperature of about 300 F to about 400 F depending upon the length of heating time). However, the cure response of the metallic diacrylate or dimethacrylate can also offer advantages over systems cured with dicyandiamide or other conventional cures. That is, the inventive acrylates curing ability is a generally linear function of time vs temp, rather than a relatively sharp peak at the melt point of a curing agent (e.g., as with dicyandiamide curing agents). Clarity, adhesion and stability, compatibility with fillers such as high ph silicates, plastic, and metallic powder, reactive resins among others, are aspects of the epoxy functional systems which can be improved with the inventive metallic diacrylate curing agent. Formulations of expandable sealers and adhesives can also be enhanced with the use of metallic diacrylates. The cure response of the metallic diacrylates with epoxy functional compounds permits using a wide range of foaming agents, fillers, resins, and polymers in order to tailor the formulation for a particular end use.

Epoxy functional systems which incorporate at least one metallic acrylate (e.g., metallic acrylate, metallic diacrylate, metallic dimethacrylate or metallic monomethacrylate), as the curing mechanism have mechanical properties similar to conventionally cured formulas. The cure response is not dependent on melting point, but is normally time and temperature dependent. This can be very advantageous for many processes such as metal part painting, electronic component, aerospace, among other uses. End use applications can achieve desired mechanical properties such as toughness and flexibility among others, by adjusting time and temperature for each specific need.

The metallic diacrylate can have a structure comprising:
C₃H₄O_{2.1}/2M

wherein M can comprise at least one member selected from the group consisting of zinc (e.g., 2-propenoic acid zinc salt), aluminum, magnesium, tin, copper, nickel, aqueous solutions of acrylate (e.g., aqueous solutions of metallic acrylate monomer such as zinc acrylate monomer), among others. While any suitable metallic diacrylate or ZDA/ZDMA compounds or modified ZDA/ZMA compounds can be employed, examples of commercially available ZDA/ZDMA products comprise: SR 633, SR 634, SR 9016, CN 2401, CN 2400, PC 300, PRO 5903, M Cure 204, SR 705, SR 706, SR 709 and aqueous dispersions or solutions of zinc acrylate and a non-metallic acrylate monomer such as CD 664 and CD 665 all of which are available from Sartomer, Exton Pa. Non-metallic acrylates (and other compatible organic compounds) can be combined with the metallic diacrylate in order to modify the system, increase cure rate or hardness, among other beneficial improvements. The particle size of the metallic diacrylate or dimethacrylate can be varied thereby permitting production of thin and thick film formulations (e.g., Sartomer® CN2400 and CN 2401 are commercially available as liquids; SR 9016 comprises particles ranging from about 40 to about 50 microns and SR 633 comprises particles having a standard 200 mesh). If desired, the metallic diacrylate or dimethacrylate can be dispersed or dissolved within at least one carrier prior to compounding into a system, e.g., water and other solvents. When the metallic diacrylate comprises ZDA/ZDMA, the amount of ZDA/ZDMA ranges from about 1 to about 75 wt. % and typically about 5 to about 20 wt. % of metallic diacrylate (e.g., about 5 to about 10 wt. % for an epoxy functional system).

In one aspect of the invention, ZDA/ZDMA cured epoxy systems are more compatible with additives and fillers. This allows greater versatility in the formulation of epoxy, melamine, isocyanurates, polysiloxane, alkyds, phenolic modified alkyds, acrylic alkyd copolymers, polyesters, epoxy esters and polybutadiene containing systems, e.g., adhesives, sealers, coatings, among other systems. In contrast to conventional curing agents such as dicyandiamides, the inventive system permits curing epoxy containing systems that include high pH silicate fillers (e.g., a system comprising epoxy, calcium silicate and metallic diacrylate). Such systems are normally difficult, if not impossible, to cure with conventional curing agents due to an undesired interaction or reaction between dicyandiamide and calcium silicate (e.g., which can cause the composition to foam).

Formulations or systems of the instant invention can be compatible with a wide range of filler materials. Examples of such filler materials comprise at least one from the group consisting of silicates such as calcium, sodium, potassium, lithium, aluminum, magnesium, among others; trihydrates such as aluminum trihydrate; carbonates, bitumins (e.g., gilsonite), clays, nitrides such as aluminum nitride, boron nitride and silicon nitride, carbides such as silicon carbide, silica, metallic powders (e.g., ferrous and non-ferrous metals such as copper, zinc, aluminum, iron, among others), among other fillers. In some cases, the filler materials can be employed for modifying the characteristics of the sealant/sound abatement material such as reducing shrinkage, increase or decrease the specific gravity, increase or decrease compression and recovery properties, among other surface characteristics. The amount of filler can vary depending upon the desired properties in the cured formulation, and will typically range from about 1 to at least 70 wt % (e.g., about 5 to about 25 wt. %).

The instant invention can be employed for tailoring the curing rate. Conventional curing agents typically have a rapid cure which is undesirable for certain applications. The curing rate of the instant invention can be increased by exposure to higher temperatures, and decreased by lower temperatures. The ability to control curing rate (and temperature) is desirable in that such permits finished coating surfaces to be optimized for smoothness, hardness, gloss, and clarity. Generally a higher curing temperature also results in an increased hardness.

The instant invention can be employed for tailoring the activation temperature of formulations. The activation or curing temperature can range from about 275 to about 425° F. depending upon the thickness, amount of curing agent, composition of system being cured, method of heating, among other conventional variables. Generally a thinner coating will require less heat and time to cure, and the higher the curing temperature the harder the resultant coating. Additions of titanates, zirconates, among other complexing agents can be used for lowering the cure temperature of the inventive formulations. The amount of complexing agent will normally range from about 0.1 to about 20 wt. % of the composition or formulation. For example, adding 1-5% of a commercially available titanate (Lica 38J supplied by Kenrich) is effective at lowering the cure temperature of formulations containing epoxy functional compounds as the base polymer (e.g., to a cure temperature to less than 250° F.). If desired the complexing agent can include a functional component such as a methacrylamide functional amine adduct.

In one aspect of the invention one or more additives are included in the inventive formulations. Examples of such additives comprise at least one member selected from the group of fillers, metal powders (e.g., zinc, aluminum, iron, steel, copper, among other metal powders), magnetic materials (e.g. strontium ferrite, barium ferrite among other magnetic materials), ceramic powders, plastic powders, resins (e.g., silicone, silanes, polysiloxanes), fibers, plates, bubbles, spheres, antioxidants, brighteners-colorants-dyes, calcium carbonate, cellulose complexes (e.g. methyl, etc.), clays, corrosion inhibitors, flame retardants (e.g. aluminum trihydrate, zinc borate, etc.), Gilsonite, glass, light absorbers incl V, oxide complexes (e.g. calcium, zinc, etc.), phosphate complexes (e.g. zinc, etc.), polyvinyl alcohol, reactive fillers (e.g. epoxy functional, phenoxy, etc), silica and silicates, stearate complexes (e.g. lithium, zinc, etc.), talcs, thermal stabilizers, whitening agents, among others. Formulations incorporating at least one polysiloxane, at least one metallic powder and at least one ceramic powder can be used when increased temperature resistance is desired (e.g., a coating or formulation formed into a sealant that is employed in or around the engine compartment or exhaust system). These additives will normally comprise about 1 to about 70 wt. % of the composition (e.g., 50 to 70 wt. % of the composition).

In another aspect of the invention, the inventive system is placed (e.g., extruded, pumped, dipped, sprayed, brushed applied or wiped on), upon a reinforcement. The reinforcement can be located upon or within the inventive blend, e.g., a sandwich or laminate structure. The reinforcement permits easier handling during application and/or manufacture, reduces flow (or sagging) when the inventive system is exposed to increased temperatures, increases tensile strength, improves abrasion resistance, among other characteristics. Depending upon the desired properties, e.g., temperature resistance, the reinforcement material can comprise any suitable material. The reinforcement material normally comprises a scrim, web, matte, mesh, perforated or unperforated polymer films, an unwoven or a woven assemblage, among other fibrous or film type reinforcements. When employing a scrim as the reinforcement (e.g., a fiberglass scrim having generally round fibers and approximately 12 squares per inch), the reinforcement can have an open surface area of greater than 20 to at least about 80%. When the reinforcement material comprises a perforated polymer or metallic film, the reinforcement material can have an open surface area or porosity of about 1 to at least about 80%. The open surface area also allows a reinforced system to retain its flexibility. Examples of suitable reinforcement materials comprise fiberglass, polypropylene, polyethylene, polyester, fluoropolymers, graphite, plastics, Kevlar®, aluminum, steel, copper, brass, cheesecloth, mixtures thereof, among other materials. Additional examples of reinforcement materials are described in U.S. Pat. No. 6,034,002, issued Mar. 7, 2000 and entitled “Sealing Tape For Pipe Joints”, and U.S. Pat. Nos. 5,120,381 and 4,983,449; each of the previous U.S. patents are hereby incorporated by reference. While the reinforcement material can have any suitable porosity or weave density, in most cases the porosity of the reinforcement material is such that the inventive composition is self-adhering (or self-sealing). For example when employing a reinforced inventive composition as a pipe wrap, the composition at least partially passes through the material in a manner sufficient for the blend to adhere to itself as the blend is being wrapped around the pipe, e.g., the blend passes through the reinforcement thereby permitting the blend to bond to itself. The self-adhering characteristic normally obviates the need for primers or pre-treatments, and increases the efficiency with which the reinforced composition covers a surface. In another example, bubbling, blistering or off-gassing of the tape or coating during the cure process can be reduced, if not eliminated, by employing a reinforcement. Reducing bubbling or blistering is particularly desirable if the inventive system is employed as a paintable automotive sealant (e.g. so-called automotive “roof ditch” sealant).

If desired, the reinforcement material can be coated or pretreated with an emulsion, dispersion, UV reactive (including reactive to sunlight), electron beam reactive, water or solvent based systems, 100% solids, powder coat systems, or other composition for sizing the reinforcement material, e.g., the reinforcement material is coated with an emulsion for increasing the rigidity of the material thereby permitting the material to be cut to a predetermined size or configuration. The coating can be applied by any suitable methods known in the art such as dipping, laminating, spraying, roller coating, pumping, among others. Examples of suitable coatings for the reinforcement material comprise at least one of acrylic, alkyds, epoxy, epoxy esters, ethylene vinyl acetate, polyesters, polyvinyl alcohol, silicates, urethane, polyurethane or latex dispersions or emulsions. Another example of a suitable coating for the reinforcement material comprises epoxies, oligomers, monomers, additives, a photo-initiator (e.g., ionium salts), and may include a curing agent (e.g., peroxides, conventional epoxy curing agents, metallic acrylates/diacrylates/dimethacrylates/monomethacrylates or blends thereof).

In one aspect of the invention, the inventive materials comprise automotive sealants and sound abatement materials that can be used for filling and sealing cavities, sealing between metal seams or flanges, sealing over metal seams or flanges, seal holes and gaps, increase localized structural integrity, seal an area while offering a cosmetic appearance, among other uses. If desired, the sealant or sound abatement material can be maintained at a fixed location within or adjacent to a cavity to be sealed or filled by using at least one fastener. Examples of suitable fasteners comprise at least one member selected from the group of pins, clips, shelves, among others. The fastener can be directly connected to the material or associated with a support that carries the material.

In another aspect of the invention, the inventive composition comprises an automotive structural sealer which can be expanding or non-expanding. (e.g., at least one metallic acrylate and at least one member from the group of epoxidized elastomers, rubber modified epoxies and epoxy elastomer blends). Using the inventive metallic diacrylates as a curing mechanism can offer advantages in formulation options and product physical properties than formulas cured with conventional curing systems. Improved cure response and increased compatibility with other materials have been observed in formulations cured with metallic diacrylates. Formulas intended for use as automotive adhesives, sealers and sound abatement materials are especially suited to metallic diacrylate cure systems, because of the current paint curing systems already existing in most facilities. Many joints, seams, gaps and holes on vehicles require or can be improved with the use of structural sealers and adhesives. Cosmetic, safety, and quality concerns are the primary reasons for selecting structural adhesives and sealers in specific applications. In addition fillers, thixotropes, foaming agents and pigments are added to achieve the required texture, color, or other physical characteristics that are necessary for application. The structural sealer can be cured by convection heat, induction heat, or radiant heat.

The elevated temperature melt point of powder resins allows the incorporation of the powder resins into the inventive compositions (e.g., tapes or paste formulations) without the resin being dissolved into the composition. The resin typically remains suspended in the composition, and provides properties very similar to formulas using non-reactive fillers to adjust the consistency of the composition. When the composition is heated to the activation point of the reactive resin, increased strength and toughness can be greatly improved over formulas which contain non-reactive fillers. Use of epoxy reactive resins cured with metallic diacrylates can be especially useful in structural sealers and adhesives used in the automotive industry

In another aspect of the invention, formulations containing the metallic diacrylate curing agent have an improved shelf life relative to conventional curing agents. For example, the inventive formulation is normally stable for at least 120 days without special packaging or refrigeration whereas formulations containing conventional curing agents are typically stable for about 90 days.

In one aspect of the invention, the sealant has improved paint compatibility such as reduced staining of an overlying paint. Paint staining can occur when employing epoxy based compositions, and in most cases this is caused by the epoxy hardeners that are commonly used. This problem can be solved by using the instant ZDA curing agent. The cure response of the metallic acrylate cured epoxy formula can also be beneficial to sealers and adhesives used in painted systems. Sealers and adhesives can typically be thermoset at lower activation temperatures in comparison to dicyandiamide cured compositions.

Ethylene acrylate polymers (Vamac), EMA resin, Phenoxy resin, flouropolymer, polysiloxane, and blends of various solid and liquid epoxy resins are particularly useful in formulating compositions for use in applications requiring painting. These polymers can be used as a substitute for acrylonitrile polymers in many formulations. Metallic acrylates are very compatible with these types of polymers and resins and provide a viable alternative with improved paint compatibility than conventional epoxy cures. Such formulations can incorporate radiation (e.g. ultra violet or electron beam) curing initiators with the metallic acrylates for two component curing of sealers and adhesives. This can be useful in applications which require a gel or pre-cure stage prior to heat curing. Tapes, gels, thixotropic compositions, among others can be partially activated with UV for surface skinning, to enhance sag resistance and handling properties (one side dry/one side tacky), or to enhance dimensional stability prior to final cure in heat processing.

When an expandable material is desired, the blowing or foaming agent can comprise one or more of the blowing agents recognized in the foam-forming field. Example of suitable blowing agents include water, hydrazide, diphenyloxide-4,4-disulphohydrazide, carbonamide, azocarbonamide, hexamethylene diamine carbamate, sodium bicarbonate, dimethyl ether, methylene chloride, carbon dioxide, fluorocarbons such as difluoroethane, tetrafluoroethane, HFC-4310, azeotropes and isomers thereof, among others; and hydrocarbons such as isobutane, butane, propane, pentane, isopentane, alcohol, isomers thereof; mixtures thereof, among other known blowing agents. An example of suitable foaming agent comprises a nitrogen releasing chemical blowing agents such as those supplied as Celogen® by Crompton. Normally, the foaming agent comprises about 1 to about 40 wt. % of the composition.

In one aspect of the invention, a liquid or gaseous blowing agent is combined with or encapsulated within a thermoplastic particle or powder, e.g., a hydrocarbon encapsulated within an acrylonitrile shell as in Expancel® that is supplied by Expancel Inc., a division of Akzo Nobel Industries (e.g., as Expancels® 051WU, 051DU, 091DU80, 820WU, 820DU, 642WU, 551WU, 551WU80, 461DU) or by Sovereign Specialty Chemicals (e.g., Micropearl® F30D). The encapsulated blowing or foam agent can comprise a gas (e.g., blowing agent (isobutane, isopentane, etc) encapsulated in a polymer shell (2-methyl 2-propenioc acid methyl ester polymer with 2-propenenitrile and vinylidene chloride polymer and polyvinylidene fluoride, etc). The shells or encapsulating material can be fabricated from polyolefins such polyethylene and polypropylene; vinyls, EVA, nylon, acrylics, among other materials. The shells are selected to melt, soften, expand, rupture or retain their physical configuration depending upon whether or not an open or closed cell foam is desired. The shells can also comprise a distribution of differing particle sizes, composition and activation temperatures, e.g., a foam precursor comprising at least two different particle sizes and activation temperatures. A foam comprising particles having a range of sizes and compositions is especially desirable when producing an acoustical foam. The acoustical properties of a foam can also be improved by employing particles encapsulating blowing agents of more than one composition, e.g., employing shells encapsulating differing blowing agents. These materials can be supplied in either dry or wet form. These materials can also be coated with any suitable material for controlling the activation temperature of the encapsulated blowing agents. An example of a coating comprises acrylated materials, waxes, among other materials.

The inventive sealants and sound abatement materials can be blended by using any suitable equipment such as a Baker-Perkins double arm mixer, Ross type mixer, dissolvers or dispersers, continuous mixers, among other mixers. Once the ingredients of these materials are blended, the blended materials can be fabricated into a wide range of configurations such as tapes, die cut shapes, strips, beads, parts with varying thickness and/or shapes, among others. These materials can be fabricated by extruding, calendaring, continuous mixing/extrusion, pumping, roller coating, spraying, brush-on, pumping, among other fabrication or application methods.

The combinations of the instant invention can be applied onto an automobile, automobile sub-assembly, or other industrial applications by any method such as manual or robotic applications. When used for automotive applications the combinations of the invention can be used in the following areas: roof panel supports, quarter panels, rear deck lid, hood, rocker panels, roof pillars, intrusion beams, firewall, and exterior panel. The composition can be manufactured in preformed parts, tape or pumpable form (e.g., a pumpable composition that subsequently foams when exposed to a sufficient amount of heat). If desired, the inventive combinations fabricated into a tape form can dispensed or applied by using the apparatus and method described in U.S. patent application Ser. No. 10/087,930 (Sharp); hereby incorporated by reference.

The following Examples are provided to illustrate certain aspects of the invention and shall not limit the scope of any claims.

### EXAMPLE 1

The following Table 1 illustrates a ZDA cured tape sealant that has reduced paint staining in comparison to a dicyanimide cured sealant. The formula of Table 1 was mixed in a double arm lab mixer. The polymer was slowly reduced with liquid components and powders to obtain smooth homogeneous mixture.

The tape sealant was placed upon a steel test panel and cured in a Despatch mechanical convention oven for 30 minutes at 350 F. A white automotive enamel was applied upon the cured sealant and the paint was cured at 280 to 325 F for 30 minutes. The paint stain resistance was tested by heat aging at a temperature of 150 F for 7 days (alternatively, the resistance can be evaluated by exposing the painted sealant to UV light for 96 hrs).

TABLE 1

| Tradename | Compound | Supplier | Wt % |
|---|---|---|---|
| Epon 828 | epoxy resin | Resolution | 20% |
| TC 140 | Ethylene methylacrylate | Exxon Mobil | 12% |
| Vamac G | Ethylene Acrylic polymer | DuPont | 15% |
| Epon 1002 | Solid epoxy resin | Resolution | 15% |
| LD 80 | Metallic powder | Pyron | 20% |
| FP 800 | Polypropylene powder | Equistar | 15% |
| SR 9016 | Zinc Diacrylate | Sartomer | 3% |

### EXAMPLE 2

The following Table 2 illustrates a ZDA cured gel/mastic formula. The formula of Table 2 was mixed in a double arm lab mixer. The polymer was slowly reduced with liquid components and powders to obtain smooth homogeneous mixture. This formula was cured by heating at a temperature of 350 F for 30 minutes in a Despatch mechanical convention oven.

TABLE 2

| Tradename | Compound | Supplier | Wt. % |
|---|---|---|---|
| LER HH | Phenoxy/Epoxy blend | InChem | 50% |
| Vamac G | Ethylene acrylic polymer | DuPont | 15% |
| TC 140 | Ethylene methacrylate | Exxon/Mobil | 5% |
| LD 80 | metallic powder | Pyron | 15% |
| FP 800 | Polypropylene powder | Equistar | 10% |
| SR 9016 | Zinc Diacrylate | Sartomer | 5% |

### EXAMPLE 3

The following Table 3 illustrates a structural mastic/sealant formulation. The formula of Table 3 was mixed in a dual arm baker perkins lab mixer. Polymer resin was added and additions of powder and resin were slowly blended to keep a homogeneous mixture. The formulation was cured by heating to a temperature of 350 F for a period of 30 minutes in a Despatch mechanical convention oven.

TABLE 3

| Tradename | Compound | Supplier | Wt. % |
|---|---|---|---|
| Vamac G | ethylene acrylic polymer | DuPont | 7% |
| P100 | metallic powder | Pyron | 43% |
| Zinc Oxide | AZO 77 | US zinc | 1% |
| EMR RK8-4 | epoxy blend | CVC | 13% |
| SR 9016 | zinc diacrylate | Sartomer | 2.5% |
| MP 30-36 | magnesium silicate | Pfizer | 5% |
| Epon 1002 | epoxy resin | Resolution | 5% |
| LER HH | phenoxy/epoxy blend | InChem | 22.5% |
| Dicup 40KE | Dicumyl peroxide | Akrochem | 1% |

### EXAMPLE 4

The following Table 4 illustrates a structural film formulation. This film can be employed alone or upon a wide range of sealants. The formula of Table 4 was mixed in a dual arm baker perkins lab mixer. Polymer resin was added and additions of powder and resin were slowly blended to keep a homogeneous mixture.

After mixing the formulation, an approximately 5 mil thick film was prepared by using a lab press heated to a temperature of about 170 F (alternatively a film could be obtained by extruding the formulation on a Bonnot extruder heated to about 170 F-180 F). The film was cured at a temperature of 350 F for 30 minutes in a Despatch mechanical convention oven.

TABLE 4

| Tradename | Compound | Supplier | Wt. % |
|---|---|---|---|
| Vamac G | ethylene acrylic polymer | DuPont | 10% |
| P100 | metallic powder | Pyron | 34% |
| Regal 300 | carbon black | Cabot | .5% |
| Zinc Oxide | AZO 77 | US zinc | .5% |
| EMR RK8-4 | epoxy blend | CVC | 4% |
| SR 9016 | zinc diacrylate | Sartomer | 2.5% |
| TC 140 | ethylene methacrylate | Exxon/Mobil | 18.5% |
| SER10 | phenoxy/epoxy blend | InChem | 17% |
| Epon 1002 | epoxy resin | Resolution | 12% |
| Vulcup 40KE | peroxide | Akrochem | 1% |

### EXAMPLES 5-7

Chemical or thermal expanding agents can also be used to form expanded cellular or foamed components (e.g., sound abatement materials). Examples of expansion agents comprise Celogen OT (an oxysulfonal hydrazide chemistry), Celogen AZ [azodicarbonimide chemsitry] (Crompton), Expancel [encapsulated hydrocarbon] (Akzo Nobel), among others. These expansion agents expand when exposed to a sufficient amount of heat in order to form closed cell foam articles.

The following Tables 5-7 illustrate formulas that were used to obtain foamed material. After mixing in a dual arm baker perkins lab mixer, the formulations were heated to a temperature of 350 F for 30 minutes in a Despatch mechanical convention oven thereby producing a foamed material.

TABLE 5

| Tradename | Compound | Supplier | Wt. % |
|---|---|---|---|
| Vamac G | ethylene acrylic polymer | DuPont | 10% |
| P100 | metallic powder | Pyron | 34% |
| Regal 300 | carbon black | Cabot | .5% |
| Zinc Oxide | AZO 77 | US zinc | .5% |
| Celoget OT | blowing agent | Crompton | 2% |
| EMR RK8-4 | epoxy blend | CVC | 4% |
| SR 9016 | zinc diacrylate | Sartomer | 2.5% |
| TC 140 | ethylene methacrylate | Exxon/Mobil | 18.5% |
| SER10 | phenoxy/epoxy blend | InChem | 15% |
| Epon 1002 | epoxy resin | Resolution | 12% |
| Vulcup 40KE | peroxide | Akrochem | 1% |

TABLE 6

| Tradename | Compound | Supplier | Wt. % |
|---|---|---|---|
| Vamac DP | ethylene acrylic copolymer | DuPont | 20% |
| Regal 300 | carbon black | Cabot | .5% |
| Zinc Oxide | AZO 77 | US zinc | .5% |
| Celogen OT | blowing agent | Crompton | 2% |
| SR 9016 | zinc diacrylate | Sartomer | 3.5% |
| Epon 828 | epoxy resin | Resolution | 28.5% |
| SER10 | phenoxy/epoxy blend | InChem | 15% |
| Epon 1002 | epoxy resin | Resolution | 12% |
| Vulcup 40KE | peroxide | Akrochem | 1% |
| Magsill 399 | magnesium silicate | Whittaker Clark | 17% |

TABLE 7

| Trademark | Compound | Supplier | Wt. % |
|---|---|---|---|
| Vamac DP | ethylene acrylic copolymer | DuPont | 15% |
| Celogen OT | blowing agent | Crompton | 10% |
| SR 9016 | zinc diacrylate | Sartomer | 4% |
| Epon 828 | epoxy resin | Resolution | 30% |
| Epon 1002 | epoxy resin | Resolution | 20% |
| Vulcup 40KE | peroxide | Akrochem | 1% |
| Aerosil 200 | Fumed silica | DeGussa | 20% |

### EXAMPLE 8

Example 8 demonstrates a foaming composition that can be pumped into a predetermined location and then expanded by heating. The components of Table 8 were blended in order to produce a pumpable and expandable composition.

Vamac DP was blended with Epon 828 in a Baker Perkins sigma mixer to obtain a 20 wt. % Vamac and 80 wt. % Epon 828 blend. This mixture was added to a Ross planetary mixer, and remaining ingredients of Table 8 were added. The composition was mixed under vacuum for 15 minutes. The composition was heated in a mechanical convection oven at 177 C for 30 minutes thereby producing an expanded or foam product.

The composition can be dispensed from tubes using a Semco gun model 250 A, and Grayco pump system King series A99A (or other comparable pump systems).

TABLE 8

| Trademark | Compound | Supplier | Wt. % |
|---|---|---|---|
| Vamac DP | ethylene acrylic copolymer | DuPont | 13% |
| Celogen OT | blowing agent | Crompton | 10% |
| SR 9016 | zinc diacrylate | Sartomer | 6% |
| Epon 828 | epoxy resin | Resolution | 30% |
| Epon SU2.5 | epoxy resin | Resolution | 30% |
| Vulcup 40KE | peroxide | Akrochem | 1% |
| Aerosil 200 | Fumed silica | DeGussa | 10% |

While the above Description emphasizes usage of the instant compositions in automotive applications, the compositions can be used in a wide range of uses. Other applications include, without limitation, appliance, aerospace, watercraft, and specialty vehicle. For example, the inventive epoxy formulations can be supplied as bulk composition for pumping, tape for manual and robotic applications, and precut shapes. The instant use of metallic acrylates and diacrylates can be very useful as curing agents in epoxy formulations designed to expand with thermal energy, and impart structural properties to the intended application. Applications such as automotive, aerospace, and industrial paint systems, which use thermal energy to react the paint have been particularly well suited for heat activated epoxy or other reactive resin formulations. The metallic acrylate (diacrylate) curing system works very well with conventional epoxy and blowing agent compositions to yield useful foam products which impart structural integrity, sound abatement, and energy absorption with reduced weight. The controlled cure response of the metallic acrylate (diacrylate) offers greater flexibility to the formulator when manufacturing compositions for structural cellular products. Flooring, cavity fillers, composite panels, and molded products are typical end products which can be formulated using metallic acrylate (diacrylate) cured epoxy foam compositions

The following is claimed:

1. A heat curable automotive sealant comprising at least one heat curable epoxy resin, at least one curing agent selected from the group consisting of zinc diacrylate and dimethacrylate, and at least one complexing agent; wherein the combination is substantially free of peroxides and other conventional epoxy curing agents.

2. An expandable heat curable sealant comprising at least one blowing agent, at least one epoxy functional resin compound, and at least one curing agent selected from the group consisting of metal acrylate, metallic mono-methacrylates and metallic dimethacrylates, wherein the composition is substantially free of peroxides and conventional epoxy curing agents.

3. A thermoset automotive sealant composition comprising at least one filler, at least one polymeric additive, at least one epoxy functional compound, and at least one curing agent comprising at least one member selected from the group consisting of zinc diacrylate and dimethacrylate wherein the composition is substantially free of peroxides and other conventional epoxy curing agents.

4. The sealant of claim 2 wherein the compound comprises at least one member selected from the group consisting of bis A epoxy, bis F, cycloaliphatic epoxy, novolac compounds and epoxy esters.

5. The sealant of claim 2 wherein the composition further comprises at least one filler selected from the group consisting of at least one silicate, silica, trihydrates, carbonates, bitumins, and clays.

6. The sealant of claim 2 wherein the composition further comprises at least one additive selected from the group consisting of metal powders, magnetic materials, ceramic powders, plastic powders and resins.

7. The sealant of claim 3 wherein the composition further comprises at least one fiberous reinforcement.

8. The sealant of claim 1 wherein said at least one complexing agent comprises at least one member selected from the group consisting of silanes, zirconates and titanates.

9. The sealant of claim 2 wherein the metal acrylate curing agent comprises at least one member selected from the group consisting of zinc diacrylate, zinc dimethacrylate, magnesium diacrylate, mixtures thereof and aqueous solutions thereof.

10. The sealant of claim 2 wherein the metal acrylate curing agent comprises at least one of zinc diacrylate and dimethacrylate.

11. The sealant of claim 10 wherein the metal acrylate curing agent comprises zinc diacrylate.

12. The sealant of claim 2 further comprising at least one member selected from the group consisting of silanes and polysiloxanes.

13. The sealant of claim 2 further comprises boron nitride.

14. The sealant of claim 2 wherein the amount of metal acrylate curing agent ranges from about 5 to about 20 wt. % of the composition.

15. The sealant of claim 3 wherein said sealant is paintable and the filler comprises at least one metallic powder and the polymeric additive comprises at least one of ethylene methylacrylate and ethylene acrylic polymer.

16. The sealant of claim 2 wherein said blowing agent comprises at least one member selected from the group consisting of hydrazides, azodicarbonimides, and hydrocarbons.

17. The sealant of claim 2 wherein said blowing agent comprises at least one member selected from the group consisting of water, hydrazide, diphenyloxide-4,4-disulphohydrazide, carbonamide, azocarbonamide, hexamethylene diamine carbamate, sodium bicarbonate, dimethyl ether, methylene chloride, carbon dioxide, fluorocarbons and hydrocarbons.

18. The sealant of claim 17 wherein the blowing agent is encapsulated.
